(19) United States
(12) Patent Application Publication
(10) Pub. No.: US 2018/0335012 A1
(43) Pub. Date: Nov. 22, 2018

(54) NATURAL FORCES ENERGY SYSTEM

(71) Applicants: Augusto Pezzia, Lima (PE); Renzo Pezzia, Los Gatos, CA (US)

(72) Inventors: Augusto Pezzia, Lima (PE); Renzo Pezzia, Los Gatos, CA (US)

(21) Appl. No.: 15/598,017

(22) Filed: May 17, 2017

(51) Int. Cl. F03B 17/02; F03B 15/02

(52) U.S. Cl. CPC F03B 17/02; F05B 2220/706; F03B 15/02

(57) ABSTRACT

a system for creating energy from a buoyancy-gravity cycle of a plurality of buoyant containers, cyclically moving sequentially though a liquid buoyancy column and a gravity slide, where a buoyant container captures liquid from a basin at the bottom of the system, is then inserted into the liquid column through a series of coordinatedly openable gates or valves, that maintain the liquid within the liquid column to deposit the volume of liquid into a tank that feeds a hydroelectric penstock and turbine system, to create electricity, while liquid from the tail race returns to the basin at the bottom of the system.

### CROSS-REFERENCE TO RELATED APPLICATIONS

None

### BACKGROUND OF THE INVENTION

This invention relates generally to an energy generation system that uses a buoyancy-gravity cycle, and more specifically to a system having a buoyant container to lift a volume fluid up a fluid column to a higher state of potential energy, after which the empty container controllably returns to the lower level through a dry path, to repeat the cycle as desired.

The field of art has a variety of systems that use buoyancy to lift a buoyant element through a reservoir of fluid. In many instances, the buoyant elements are connected, so that the buoyancy force on one element causes the subsequent elements to be pulled along their controlled path by the currently buoyant element. Examples include the Platt patent (U.S. Pat. No. 2,135,110), filed on May 19, 1937, where a series of containers are mounted to an endless vertically aligned chain that rotates around sprockets, which rotate shafts. The containers are closed on one end and open on the other. They face open-end up on the descent and are filled with water once submerged. On their ascent, the containers are filled with air, which causes them to capture the buoyant force of the air. The mass or weight of the containers is constant, but containers on the ascent side are “pushed” upward due to the captured air's buoyant force.

In other instances, it is the movement of the buoyant element that is captured to generate the new form of energy. The Manakkattupadeettathil patent (U.S. Pat. No. 8,516,812), filed on Mar. 19 2010, discloses an energy generation system that includes a vertical pipe filled with a liquid. A second similar pipe is connected to the first pipe near its top end above the top of the liquid. Hollow spheres each fit within the first pipe and float. The second pipe allows downward passage of spheres lifted into the second pipe by a sphere-lifting mechanism. A platform close the bottom of the apparatus is positioned to be impacted by sphere descending in the second pipe. The platform moves in response to the impact, and turns a rotatable flywheel before being reset by a spring apparatus. A sphere injector then injects a sphere back into the first pipe, so it floats to the top once more.

The Pirincci patent (U.S. Pat. No. 8,756,932), filed on Nov. 14, 2011, discloses an energy generation system that employs mainly solid, spherical, buoyant bodies to circulate up by buoyance and down by gravity, to activate an alternator in the downward state. Then, the Spataro application (U.S. 2010-0031651), published on Feb. 11, 2010, discloses a submersible buoyancy motor that has a water-filled “up” leg and an air-filled “down” leg joined at the bottom by a transfer passage. Energy is captured from the upward motion of the floats. Buoyant floats move through the transfer passage from the air environment to the water environment by either a set of regulated, sequenced gates, or a paired piston system. And soon thereafter, the Sabapathy application (U.S. 2010-0126804), published on May 27, 2010, discloses a buoyancy energy generator where buoyant rollers are designed to travel up a buoyancy chamber and down a gravity system where the weight of the roller actuates a mechanism to capture energy, before being returned to the buoyancy chamber. A subsequent mechanism captures additional potential energy from the roller to transfer an additional roller from the buoyancy chamber to the gravity system.

It would be an improvement to the field of art to have an energy generation system that employs independently moveable, buoyant containers that may transport liquid to a higher potential energy state, as well as the various subsystem developed to effectuate such buoyancy and gravity cycles of a system, as well as transition subsystems and components for moving the containers across the interface of those two cycles.

### SUMMARY OF THE INVENTION

The present development is an energy system that employs natural forces to gather elevational mechanical energy of a liquid, which in turn creates electrical energy through a controlled return to a lower elevation. The present system may include a fluid cycle system, wherein a fluid cycles from a position of high potential energy to low potential energy through a hydroelectric energy generation unit, to be captured in a lower reservoir. Liquid from the lower reservoir is transported back up to the position of high potential energy through a sequential plurality of buoyant containers. A plurality of buoyant containers may be filled with a quantity of the liquid and transported up a liquid column by the buoyancy of the container. At the top of the column, each container in sequence may deposit the liquid in a high reservoir. Each container then may return through a dry system by the force of gravity to the lower tank, where each may be filled again with a quantity of liquid, and repeat the cycle.

### BRIEF DESCRIPTION OF THE DRAWINGS

FIG. 1 is a schematic side view of an exemplary natural forces energy system according to the present invention.

FIG. 2 is a schematic side view of an exemplary container for use in the energy system of FIG. 1.

FIG. 3 a cut-away schematic side view of the exemplary container of FIG. 2.

FIG. 4 is a schematic top view of the exemplary container of FIGS. 2.

FIG. 5 is a schematic side view of the energy system in FIG. 1 at a different functional step of an operational cycle.

FIG. 6 is a schematic top view of an exemplary container fill guide.

FIGS. 7 and 8 are schematic side views of an exemplary upper and lower valves set of the energy system in FIG. 1 in varied functional steps of an operational cycle.

FIG. 9 is a flow diagram of an exemplary energy generation process according to the present invention.

### DESCRIPTION OF THE PREFERRED EMBODIMENT

In the following description, it is to be understood that the direction “down,” or related directional and orientational words, such as downward, corresponds with the direction of the force of gravity. It is also understood that “up,” or related directional and orientational words, such as upward, corresponds to the direction of the force of buoyancy. It is also to be understood that orientational words such as top or bottom are to be interpreted from the viewpoint of the subject object being normally acted upon by the forces of buoyancy or gravity.

An exemplary natural forces energy system 100 for creating energy from a buoyancy-gravity cycle may include plurality of buoyant containers 130. Such an energy system 100 may be comprised of a fluid cycle system 102 and a container cycle system 104. The fluid cycle system 102 and container cycle system 104 may be seen to work in conjunction with each other.

An exemplary container 130 may cyclically move sequentially though a container cycle system 104, which may have a liquid-filled lift column 126 and a dry return 136. In the exemplary embodiment, a buoyant container 130 may ascend the lift column 126 with a quantity of liquid, to deposit the quantity of liquid in a dump tank 110 at the top of the energy system 100. The empty container 130 may then return to the lower portion of the energy system 100 by gravity through a return 136. At the bottom of the energy system 100, the container 100 may again be filled with a quantity of liquid, and repeat the container cycle system 104.

At the same time the energy system 100 may be seen to have a fluid cycle system 102, through which a liquid may travel around a potential energy status loop from a high dump tank 110, downward to a replenish tank 112 and a head tank 114, through an hydroelectric generation system 115, to a fill tank 122 and charge tank chamber 124. The exemplary container 130 may capture a quantity of liquid from the fill tank 122 at the bottom of the system 100, and then be inserted into a lift column 126 of liquid within a vertical lift 132. A coordinated valve assembly 147 may perform the insertion into the lift column while maintaining the liquid of lift column 126 with in the vertical lift 132.

At the top of the lift 32, the container deposits the quantity of liquid into the dump tank 110, completing a cycle of the fluid cycle system 102. The container 130 continues within the container cycle system 104, and is captured by a recovery incline 134. The exemplary recovery incline 134 may direct the container 130 to a return 136. The recovery incline 134 may have perforations that permit residual water either or both on and in the container 130 to drain into either or both the dump tank 110 and the replenish tank 112. An exemplary container 130 may descend the return 136 under the force of gravity to be returned to the fill tank 122, where it may again be filled with a quantity of liquid, and reenter and progress on another iteration of the fluid cycle system 102 and the container cycle system 104. It is appreciated that once the liquid is contained within the container 130 in lift column 126, gravity provides the increase in potential energy of the transported liquid, which may mean the greater energy may be generated with a lift column of greater height, to take the contained liquid to a higher elevations with little or no additional expenditure of system management energy.

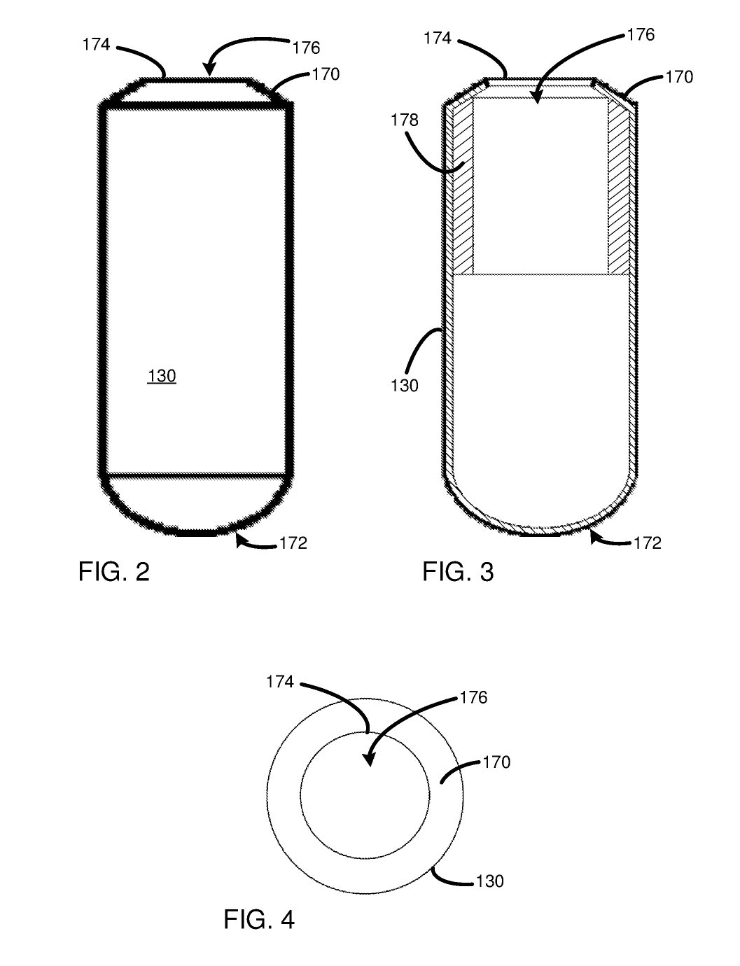

Referring now primarily to FIGS. 2 through 4, an exemplary container 130 may have an elongated, cylindrical shape. One end of an exemplary container 130 may have an angled top rim 170, and the other and may have a curved bottom 172. The angles and curves may facilitate movement throughout the container cycle system 104. The exemplary embodiment may have a container opening 174 centered in the angled top rim 170, providing liquid access to the container reservoir 176. It is appreciated that other shapes for containers may be suitable. The exemplary embodiment attempts to strike a balance between the volume the container 130 may carry, the durable buoyancy characteristics, the frictional and turbulence resistance to buoyancy, and return management characteristics. Other shapes and configurations may be suitable, and should be considered within the scope of this disclosure.

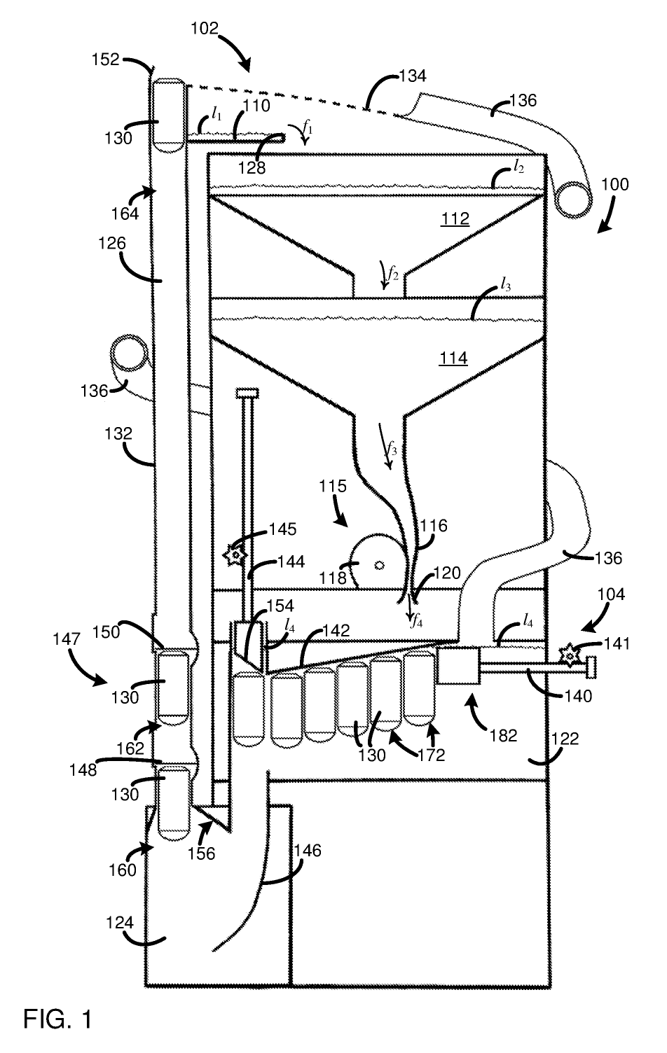

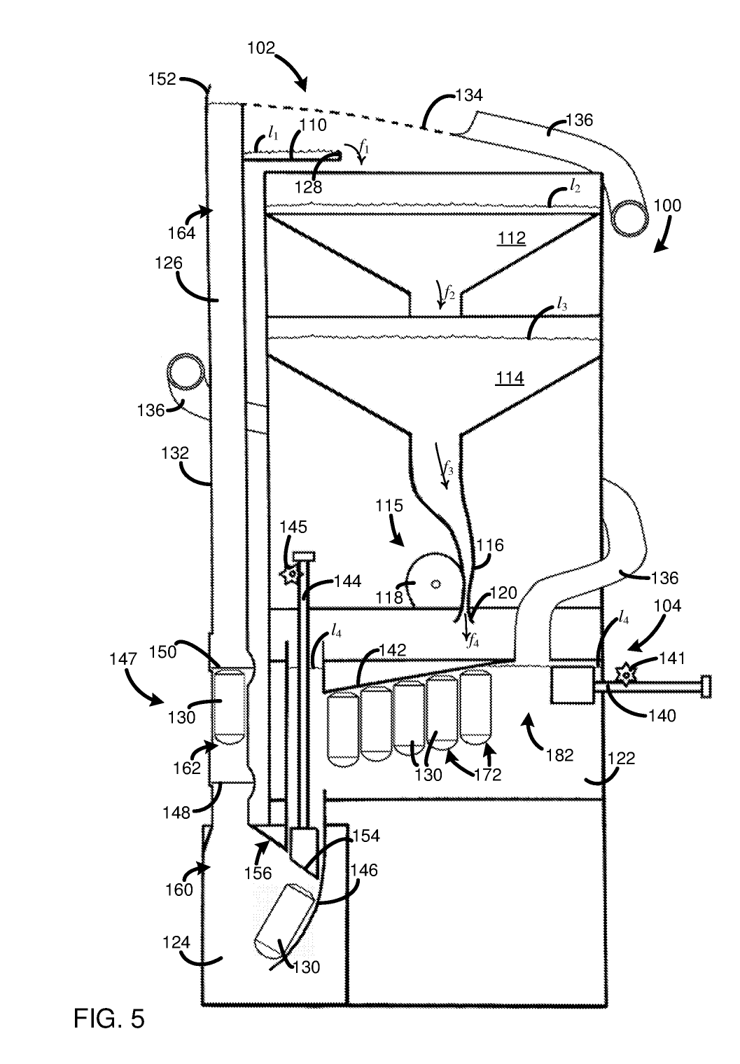

Referring now primarily to FIGS. 1 and 5, the exemplary fluid cycle system 102 and container cycle system 104 intersect at the fill tank 122, where containers 130 may be filled with the system liquid. An exemplary container 130 entering the fill tank 122, at the container entry area 182, from the return 136. The container 130 may arrive at the container entry area 182 in various positional attitudes. In the exemplary embodiment, either or both the weight of the bottom 172 of the container 130 and the buoyancy of the float 178 may induce a proper attitude for filling. Upon a container's 130 entry into the container entry area 182, fill prod 140 moves laterally (compare FIGS. 1 and 5), as driven by fill prod actuator 141, and, with the other functions of the energy system 100 that coordinatedly load containers 130 into the lift column 126, to push the containers 130 laterally along fill guide 142. The fill prod 140 may then be retracted (see FIG. 5), in preparation for the arrival of another container 130 via return 136. Exemplary fill guide 142 may be positioned along the upper surface of the fill tank 122 and angled appropriately downward and away from the fill prod 140. Repeated extension and retraction of the fill prod 140 may advance the containers 130 toward the opposite end of fill tank 122. As the containers move away from the container entry area 182, the fill guide 142 pushes them further into the liquid. At a point, liquid will fill the container reservoir 176, and the weight of the liquid within the container, along with the buoyancy of the float 178, may cause each container to assume a position with the container opening 174 directed upward, and the bottom 172 directed downward.

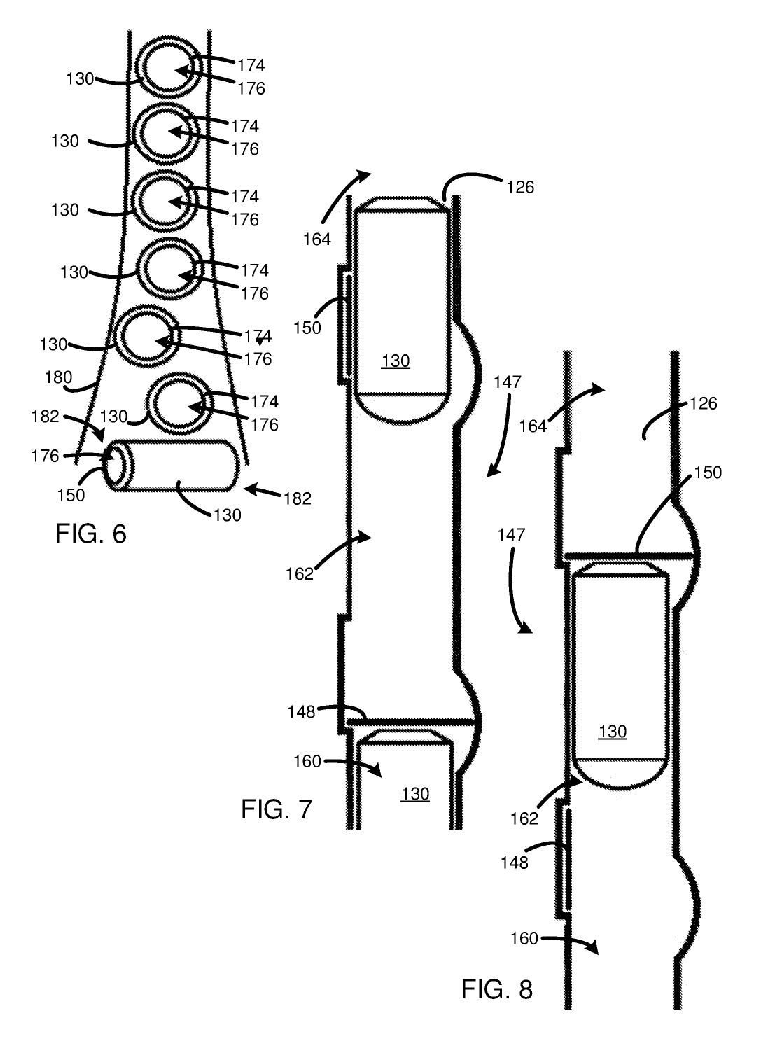

Referring now also to FIG. 6, exemplary feed guides 180 may be positioned within fill tank 122 to permit room for the containers 130 to be initially horizontal in the container entry area 182. The distance between the exemplary feed guides 180 may then narrow as the containers move away from fill prod 140, and along the fill guide 142. The distance between the two exemplary guides 180 shortens to a distance adequate to allow the passing with of a single container 130 floating upright in the liquid.

Container entry area 182 within fill tank 122 is configured to receive empty containers 130 descending return 136. In the exemplary embodiment, the empty containers 130 may enter container entry area 182 container top opening 174 first. Container entry area 182 is adequately wide to permit the container 130 to fall horizontally into the liquid. The weight of a small quantity of liquid that will enter the container reservoir 176 during the container's 130 entry into the fill tank 122, the relative weight of the container bottom 172, and the positioning of the float 178 toward the top of the container 130 may cause the container 130 to assume a generally upright position, floating in the liquid within fill tank 122. At a point along fill guide 142 and feed guides 180, a container 130 is adequately submerged that liquid enters the container top opening 174 and fills the container reservoir 176.

In the exemplary embodiment, a container 130 most recently deposited in the fill tank 122, may be pushed sideways from the container entry area 182 by the fill prod 140, which in turn may cause the container 130 to push against previously deposited containers 130. In this fashion, the containers 130 may be sequentially pushed down into the liquid within the fill tank 122. At the end of fill guide 142 opposite the fill prod 140, a container 130 may be positioned directly underneath charge prod 144.

The coordinated function of charge prod actuator 145 may cause the downward motion of charge prod 144 in concert with the other functions of the energy system 100 that coordinatedly load containers 130 into the lift column 126. The downward motion of charge prod 144 may push a particular container 130 downward into charge chamber 146. During the descent, exemplary container 130 may guided into a lift stage position 160 position under a lift column 126 by charge guide 146. In the exemplary embodiment, a sloped bottom interface 154 on charge prod 144 may interface with the angled top rim 170 to permit the container 132 to slide into a lift stage position 160 along sloped surface 156. In the exemplary embodiment, the container 132 in the lift stage position 160 floats upward against lower valve 148, which is closed to prevent the container from proceeding up lift column 126, and to help retain the liquid within lift column 126.

Referring now also to FIGS. 7 and 8, coordinated valve assembly 147, which in the exemplary embodiment comprises a lower valve 148 and an upper valve 150. Coordinated valve assembly 147, may work in concert with the other functions of the energy system 100 that coordinate the entry of sequential containers 130 into the lift column 126 contained within the lift 132. Coordinated control of the lower valve 148 and upper valve 150, such that the lower valve 148 and upper valve 150 are not open at the same time, also helps to maintain the liquid lift column 126 within the lift 132.

At a designated time, upper valve 150 may be opened to permit container 130, which may be positioned in the lift intermediate position 162 immediately below the upper valve 150, to enter the lift column 126. Ascending lift column 126 within lift column 32, the container 130 may assume an assent position 164. Assent position 164 may describe the position of a container 130 during the entire assent through lift column 126. Upon container 130 leaving lift intermediate position 162 and entering assent position 164, upper valve 150 may be closed. At that point, lower valve 148 may be opened. The opening of lower valve 148 may allow a container 130, which may be in lift stage position 162, to progress up the lift 132 and assume lift intermediate position 162, directly underneath upper valve 150. The cyclical opening and closing of upper valve 150 and lower valve 148 may be coordinated with the motion of charge prod 144 and fill prod 140 to create a smooth progression of sequential containers 130 from the fill tank 122, through the charge chamber 124, into the lift stage position 160, then the lift intermediate position 162, and then to the assent position 164.

Once through the coordinated upper valve 150 and lower valve 148, and then up lift column 126, the container 130 may arrive at the top of the lift 132, where it may exit the lift column 126. The buoyancy force on the container 130 in assent position 164 may be designed to be adequate to propel container 130 out of the surface of the liquid level l₁ of lift column 126. Upon leaving the lift column 126, a dump guide 152 may deflect the trajectory of the container 130, inducing it to travel laterally towards the dump tank 110. Liquid from the dump tank 110 may flow along flow f₁, over weir 128. The exemplary container may progress a within the container cycle system 104 along return incline 134. Return incline 134 may contain perforations to permit water to drain through and into replenish tank 112. Return incline 134 may guide the container 130 into the top of return 136, for the container's 130 gravitational dissent back to the fill tank 122.

The liquid in the dump tank 110 may naturally or upon demand, feed water to a lower replenish tank 112 as flow f₁. The liquid level l₂ in replenish tank 112 may vary, depending on the replenishment of liquid to the dump tank 110, from containers 130 ascending the lift column 126. Replenish tank 112 may then selectively release liquid into a lower head tank 114 as flow f₂. The system may be adjusted to maintain a specific liquid level l₃ in the head tank 114. The quantity of water in the head tank 114 and the liquid level l₃ may impact the fluid force of water flow f₃, and thereby the energy available to the exemplary hydroelectric generation system 115.

The head tank 114 may feed a hydroelectric generation system 115, which may include a penstock 116 to guide water flow f₃ to a turbine 118. An exemplary hydroelectric generation system 115 may create electricity from the kinetic energy of the liquid being controllably released through the penstock 116 to the tail race 120. Liquid flow f₄ from the tail race 120 may return to the fill tank 122 at the bottom of the energy system 100. Liquid flow f₄ from the tail race 120 may be the primary source for maintaining the liquid level l₄ in fill tank 122.

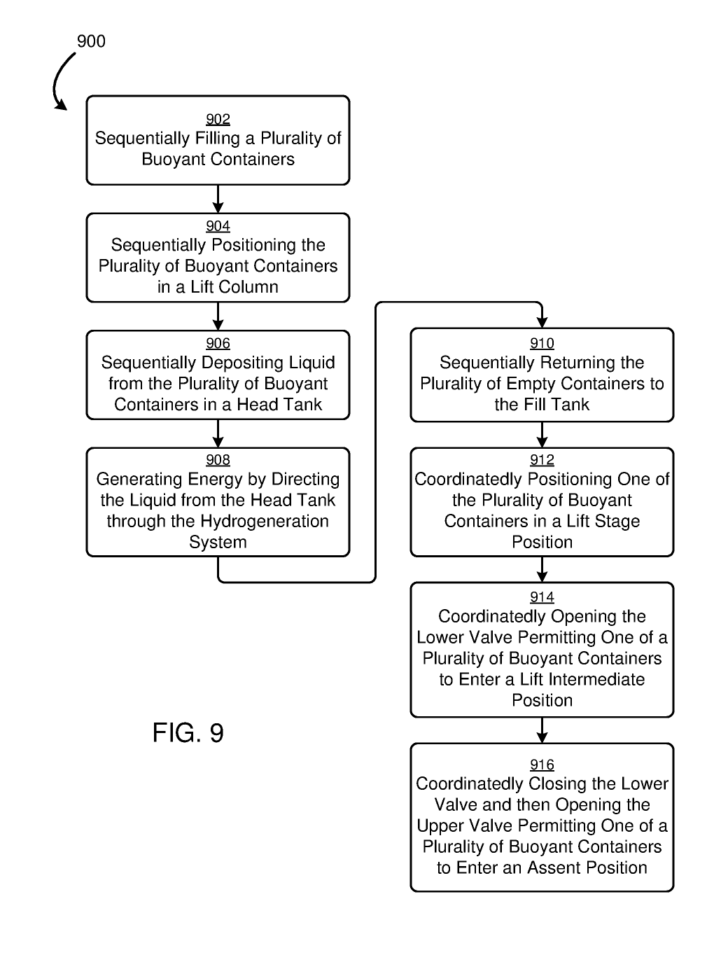

Referring now primarily to FIG. 9, an exemplary energy generation process 900 is shown that may comprise sequentially filling a plurality of buoyant containers with a liquid in a fill tank 902, sequentially positioning the plurality of buoyant containers in a lift column with a coordinated valve section, the lift column and coordinated valve sections filled with a liquid, and in fluid communication, the coordinated valve section having an upper valve and a lower valve 904, sequentially depositing liquid from the plurality of buoyant containers in a head tank, the head tank in above and in fluid communication with a hydrogeneration system, and the fill tank 906, and generating energy by directing the liquid from the head tank through the hydrogeneration system 908. This basic energy generation process may further comprise sequentially returning the plurality of empty containers to the fill tank by a gravity enabled return 910. The basic energy generation process may further comprise coordinatedly positioning one of the plurality of buoyant containers in a lift stage position below the lower valve 912. The basic energy generation process may further comprise coordinatedly opening the lower valve permitting one of a plurality of buoyant containers to enter a lift intermediate position above the lower valve and below the upper valve 914. The basic energy generation process may further comprise coordinatedly closing the lower valve and then opening the upper valve permitting one of a plurality of buoyant containers to enter an assent position above the upper valve and extending into the lift column 916.

The foregoing disclosure and description of the invention is illustrative and explanatory thereof. The examples contained in this specification are merely possible implementations of the current device and process, and alternatives to the particular features, elements and process steps, including scope and sequence of the steps may be changed without departing from the spirit of the invention. The present invention should only be limited by the following claims and their legal equivalents, since the provided exemplary embodiments are only examples of how the invention may be employed, and are not exhaustive.

It is envisioned that the scope of claims may include an energy system that comprises a fluid cycle system and a container cycle system, the container cycle system comprising a plurality of buoyant containers and a gravity enabled return; each buoyant container with a container reservoir, the fluid cycle system comprising a head tank, a hydrogeneration system, a fill tank, a coordinated valve section, and a lift column; the head tank, hydrogeneration system, fill tank, coordinated valve section, and lift column in fluid communication, and the coordinated valve section positioned below the lift column, comprising an upper valve and a lower valve. Additionally, the energy system may further comprise that the coordinated valve section has a lift stage position below the lower valve, a lift intermediate position above the lower valve and below the upper valve, and an assent position above the upper valve and extending into the lift column. Alternatively, the energy system may further comprise at least one of the plurality of containers that has a cylindrical shape with a closed end and an open end. Additionally, the closed end of the at least one of the plurality of containers being rounded. Additionally, the open end of the at least one of the plurality of containers may have a container opening supporting fluid communication between the exterior and an interior container reservoir. Additionally, the open end may have a beveled lip surrounding a container opening.

The originally described energy system could further comprise a container submersion system within the fill tank comprising an intermittent lateral fill prod, and a fill guide angled downward in the fill tank. Then, the container submersion system may be within the fill tank, and further comprise a feed guide angled toward a charge prod. In another embodiment, the container submersion system within the fill tank may further comprise two feed guides angled toward each other, the two feed guides spaced apart a distance greater than the length of one of the plurality of buoyant containers near a container entry area, and spaced apart a distance less than the width of one of the plurality of buoyant containers distal the container entry area.

Alternatively, claims may include an energy system that comprises a fluid cycle system and a container cycle system, the container cycle system comprising a plurality of buoyant containers and a gravity enabled return; each buoyant container with a container reservoir, the fluid cycle system comprising a head tank, a hydrogeneration system, a fill tank, a coordinated valve section, and a lift column; the head tank, hydrogeneration system, fill tank, coordinated valve section, and lift column in fluid communication, the coordinated valve section positioned below the lift column, and comprising an upper valve and a lower valve, the coordinated valve section having a lift stage position below the lower valve, a lift intermediate position above the lower valve and below the upper valve, and an assent position above the upper valve and extending into the lift column, at least one of the plurality of containers having a cylindrical shape with a closed end and an open end, a container submersion system within the fill tank comprising an intermittent lateral fill prod, and a fill guide angled downward in the fill tank, two feed guides angled toward each other, the two feed guides spaced apart a distance greater than the length of one of the plurality of buoyant containers near a container entry area, and spaced apart a distance less than the width of one of the plurality of buoyant containers distal the container entry area, the open end of the at least one of the plurality of containers having a container opening supporting fluid communication between the exterior and an interior container reservoir; and the open end having a beveled lip surrounding a container opening. Additionally, the closed end of the at least one of the plurality of containers being rounded.

I claim:

1. An energy system, comprising:
a fluid cycle system and a container cycle system;
the container cycle system comprising a plurality of buoyant containers and a gravity enabled return; each buoyant container with a container reservoir;
the fluid cycle system comprising a head tank, a hydrogeneration system, a fill tank, a coordinated valve section, and a lift column; the head tank, hydrogeneration system, fill tank, coordinated valve section, and lift column in fluid communication;
the coordinated valve section positioned below the lift column, and comprising an upper valve and a lower valve.

2. The energy system of claim 1, further comprising:
the coordinated valve section having a lift stage position below the lower valve, a lift intermediate position above the lower valve and below the upper valve, and an assent position above the upper valve and extending into the lift column.

3. The energy system of claim 1, further comprising:
at least one of the plurality of containers having a cylindrical shape with a closed end and an open end.

4. The energy system of claim 3 and, further comprising:
the closed end of the at least one of the plurality of containers being rounded.

5. The energy system of claim 4 and, further comprising:
the open end of the at least one of the plurality of containers having a container opening supporting fluid communication between the exterior and an interior container reservoir.

6. The energy system of claim 5 and, further comprising:
the open end having a beveled lip surrounding a container opening.

7. The energy system of claim 1, further comprising:
a container submersion system within the fill tank comprising an intermittent lateral fill prod, and a fill guide angled downward in the fill tank.

8. The energy system of claim 7, the container submersion system within the fill tank further comprising:
a feed guide angled toward a charge prod.

9. The energy system of claim 7, the container submersion system within the fill tank further comprising:
two feed guides angled toward each other, the two feed guides spaced apart a distance greater than the length of one of the plurality of buoyant containers near a container entry area, and spaced apart a distance less than the width of one of the plurality of buoyant containers distal the container entry area.

10. An energy system, comprising:
a fluid cycle system and a container cycle system;
the container cycle system comprising a plurality of buoyant containers and a gravity enabled return; each buoyant container with a container reservoir;
the fluid cycle system comprising a head tank, a hydrogeneration system, a fill tank, a coordinated valve section, and a lift column; the head tank, hydrogeneration system, fill tank, coordinated valve section, and lift column in fluid communication;
the coordinated valve section positioned below the lift column, and comprising an upper valve and a lower valve;
the coordinated valve section having a lift stage position below the lower valve, a lift intermediate position above the lower valve and below the upper valve, and an assent position above the upper valve and extending into the lift column;
at least one of the plurality of containers having a cylindrical shape with a closed end and an open end;
a container submersion system within the fill tank comprising an intermittent lateral fill prod, and a fill guide angled downward in the fill tank;
two feed guides angled toward each other, the two feed guides spaced apart a distance greater than the length of one of the plurality of buoyant containers near a container entry area, and spaced apart a distance less than the width of one of the plurality of buoyant containers distal the container entry area;
the open end of the at least one of the plurality of containers having a container opening supporting fluid communication between the exterior and an interior container reservoir; and
the open end having a beveled lip surrounding a container opening.

11. The energy system of claim 10 and, further comprising:
the closed end of the at least one of the plurality of containers being rounded.

12. An energy generation process, comprising:
sequentially filling a plurality of buoyant containers with a liquid in a fill tank;
sequentially positioning the plurality of buoyant containers in a lift column with a coordinated valve section, the lift column and coordinated valve sections filled with a liquid, and in fluid communication, the coordinated valve section having an upper valve and a lower valve;
sequentially depositing liquid from the plurality of buoyant containers in a head tank, the head tank in above and in fluid communication with a hydrogeneration system, and the fill tank; and
generating energy by directing the liquid from the head tank through the hydrogeneration system.

13. The energy generation process of claim 12, further comprising:
sequentially returning the plurality of empty containers to the fill tank by a gravity enabled return.

14. The energy generation process of claim 12, further comprising:
coordinatedly positioning one of the plurality of buoyant containers in a lift stage position below the lower valve.

15. The energy generation process of claim 12, further comprising:
coordinatedly opening the lower valve permitting one of a plurality of buoyant containers to enter a lift intermediate position above the lower valve and below the upper valve.

16. The energy generation process of claim 12, further comprising:
coordinatedly closing the lower valve and then opening the upper valve permitting one of a plurality of buoyant containers to enter an assent position above the upper valve and extending into the lift column.

17. The energy generation process of claim 12, further comprising:
coordinatedly positioning one of the plurality of buoyant containers in a lift stage position below the lower valve;
coordinatedly opening the lower valve permitting one of a plurality of buoyant containers to enter a lift intermediate position above the lower valve and below the upper valve; and
coordinatedly closing the lower valve and then opening the upper valve permitting one of a plurality of buoyant containers to enter an assent position above the upper valve and extending into the lift column.
